(19) United States
(12) Patent Application Publication
(10) Pub. No.: US 2026/0290289 A1
(43) Pub. Date: Sep. 24, 2026

(54) SETTING CONTROLLER, ELECTRONIC DEVICE, SETTING CHANGE CANCELLATION METHOD, AND NON-TRANSITORY COMPUTER-READABLE MEDIUM

(71) Applicant: CASIO COMPUTER CO., LTD., Tokyo (JP)

(72) Inventors: Tomoya KAJIKAWA, Tokyo (JP); Shingo OKANO, Tokyo (JP); Tatsuro TSUCHIYA, Tokyo (JP); Takashi YASUDA, Tokyo (JP); Saki TASHIRO, Tokyo (JP)

(73) Assignee: CASIO COMPUTER CO., LTD., Tokyo (JP)

(21) Appl. No.: 19/573,266

(22) Filed: Mar. 20, 2026

(30) Foreign Application Priority Data
Mar. 21, 2025 (JP) 2025-047006

(51) Int. Cl. G10H 1/00; G10H 1/34

(52) U.S. Cl. CPC G10H 1/0008; G10H 1/34; G10H 2220/221; G10H 2240/161

(57) ABSTRACT

A setting controller includes at least one processor and a memory. The at least one processor saves, in the memory, a setting value that is before start of a specific operation in which the setting value is changed a plurality of times and, when a single return instruction operation for making an instruction to return the changed setting value to an original state is performed after the setting value is changed the plurality of times in response to the specific operation, the at least one processor returns the changed setting value to the setting value that is before the start of the specific operation and is saved in the memory.

### CROSS-REFERENCE TO RELATED APPLICATION

This application is based upon and claims the benefit of priority from the prior Japanese Patent Application No. 2025-047006, filed on Mar. 21, 2025, the entire contents of which are incorporated herein by reference for all purposes.

### BACKGROUND

### Field

The present invention pertains to a setting controller, an electronic device, a setting change cancellation method, and a non-transitory computer-readable medium.

### Description of Related Art

In the past, an electronic musical instrument that allocates functions to various keys of a keyboard and performs a function setting that corresponds to a pressed key is known. (for example, refer to Japanese Patent Application Publication No. H9-325770).

### SUMMARY

One advantage of the present disclosure is enabling a setting value before the start of a specific operation to be easily returned to.

According to an aspect of the present disclosure, there is provided a setting controller, including:
at least one processor; and
   a memory, wherein
   the at least one processor saves, in the memory, a setting value that is before start of a specific operation in which the setting value is changed a plurality of times and, when a single return instruction operation for making an instruction to return the changed setting value to an original state is performed after the setting value is changed the plurality of times in response to the specific operation, the at least one processor returns the changed setting value to the setting value that is before the start of the specific operation and is saved in the memory.

### BRIEF DESCRIPTION OF THE DRAWINGS

FIG. 1 is a view that illustrates an example of an exterior configuration of an electronic musical instrument according to an embodiment of the present disclosure;

FIG. 2 is a block view that illustrates a functional configuration of the electronic musical instrument in FIG. 1;

FIG. 3 is a view that illustrates an example of a function allocation table; and

FIG. 4 is a flow chart that illustrates a flow of a function setting process that is executed by a control unit in FIG. 2.

### DETAILED DESCRIPTION

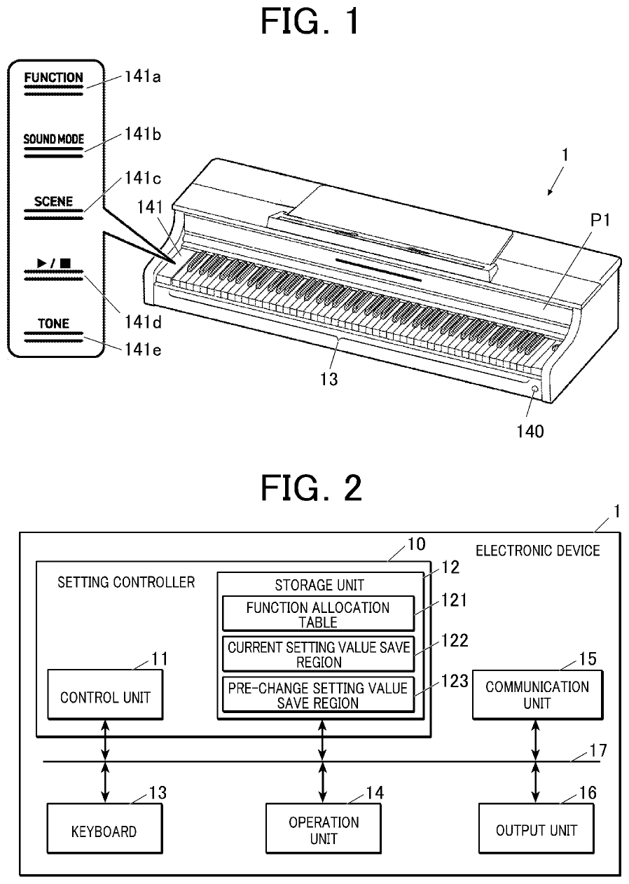

Embodiments of the present disclosure are described below using the drawings. However, embodiments described below have various limitations that are desirable in a technical fashion in order to work the present disclosure. Accordingly, the technical scope of the present invention is not limited to the following embodiment or illustrated examples. Firstly, description is given regarding a configuration of an electronic musical instrument 1 (electronic device) according to an embodiment of the present disclosure. As illustrated in FIG. 1 and FIG. 2, the electronic musical instrument 1 is configured by being provided with a control unit 11, a storage unit 12, a keyboard 13, an operation unit 14, a communication unit 15, an output unit 16, and the like. The units are connected by a bus 17. The control unit 11 and the storage unit 12 have functions that correspond to a setting controller 10.

The control unit 11 is configured by being provided with a central processing unit (CPU) that corresponds to at least one processor, a random-access memory (RAM), and the like, and is a computer that controls each unit in the electronic musical instrument 1. Specifically, the CPU in the control unit 11 reads out a program that has been designated from among a system program or various application programs stored in the storage unit 12, deploys the program to the RAM, and, in collaboration with the deployed program, executes various processes including a function setting process that is described below. The control unit 11 may have a plurality of CPUs. A plurality of processes executed by the control unit 11 according to the present embodiment may be executed by the plurality of CPUs. In this case, the plurality of CPUs may be involved in a common process. Alternatively, the plurality of CPUs may independently execute different processes in parallel.

The storage unit 12 is a memory that is configured by a non-volatile semiconductor memory, a hard disk drive (HDD), or the like. The storage unit 12 is a non-transitory computer-readable medium that stores the system program for the electronic musical instrument 1, various application programs, and data that is necessary for the programs to be executed. The storage unit 12 is not limited to being incorporated in the electronic musical instrument 1, and may include an external recording medium that can be attached to and detached from the electronic musical instrument 1, such as an external HDD or a Universal Serial Bus (USB) memory.

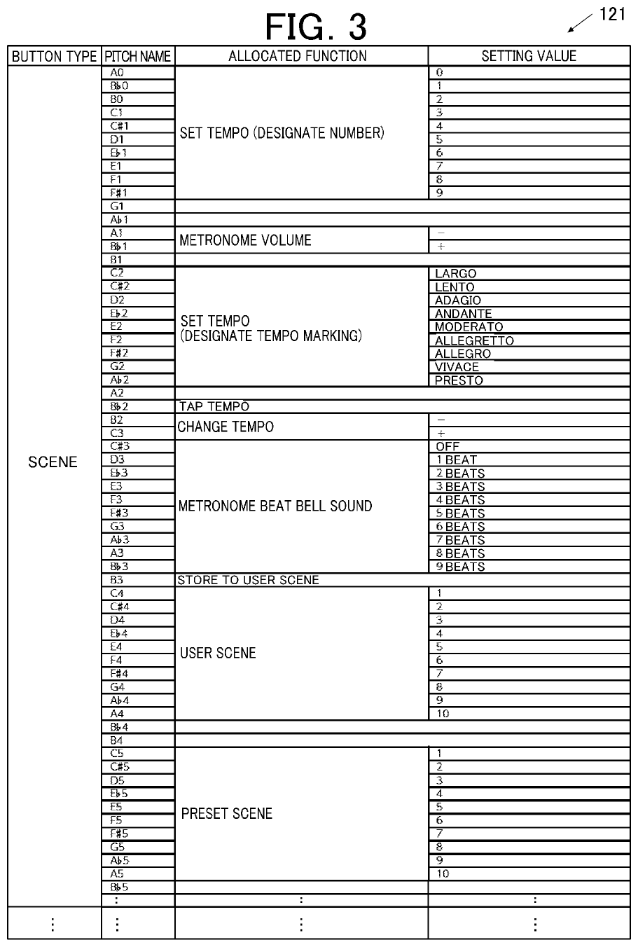

In the present embodiment, a function allocation table 121 illustrated in FIG. 3 is stored in the storage unit 12. The function allocation table 121 is a table that stores functions that are allocated to a combination of operations with respect to a later-described touch button 141 and a key of the keyboard 13, and setting values for the functions that are set when the combination of operations is performed. The storage unit 12 also stores correspondence between the note numbers and pitch names of each key of the keyboard 13.

The storage unit 12 is also provided with a current setting value save region 122 and a pre-change setting value save region 123. The current setting value save region 122 is for saving the current setting value of each function provided by the electronic musical instrument 1. The pre-change setting value save region 123 is for saving setting values that were set before changes are made to the current setting values for the various functions provided by the electronic musical instrument 1. Default values are set as initial values in the current setting value save region 122. NULL is set as initial values in the pre-change setting value save region 123.

The keyboard 13 is provided with a plurality of keys that are a plurality of controls (second controls) and enable a pitch to be designated, a detection unit that detects a key that is pressed/released, and the like. The detection unit outputs, to the control unit 11, information such as the pitch (note number) of a key that is pressed/released (note-on information/note-off information). The operation unit 14 is configured by being provided with operation buttons (first controls) such as a power supply button 140 or the touch buttons 141. Such buttons may be hardware keys or may be software keys belonging to a touch panel or the like. The operation unit 14 detects a press of the power supply button 140 or a press of a touch button 141 by a user, and outputs an operation signal to the control unit 11. For example, as illustrated in FIG. 1, the touch buttons 141 include a function button 141a, a sound mode button 141b, a scene button 141c, a start/stop button 141d, and a tone button 141e, which are provided to the left side of the keyboard 13. Note that the types of the touch buttons 141 are not limited to these. In addition, the touch buttons 141 may be provided to a front panel P1 of the electronic musical instrument 1.

The communication unit 15 is provided with a wired unit or a wireless unit for communicating with an external device, and transmits and receives data to and from the external device. The output unit 16 is provided with: a sound source unit, which has a processor configured by a digital signal processor (DSP); a D/A converter; an amplifier; a speaker; and the like. The output unit 16, in accordance with an instruction from the control unit 11, uses the sound source unit to read out waveform data that was stored in advance in a waveform ROM provided to the sound source unit or generate new waveform data, and outputs a musical tone based on the waveform data from a speaker via the D/A converter and the amplifier.

Next, description is given regarding operation by the electronic musical instrument 1 according to the present embodiment. In the electronic musical instrument 1, a setting for a function is allocated to a combination of operations of a touch button 141 and a key in the keyboard 13. When a user pressing any key of the keyboard 13 (a key press) while touching (pressing) any touch button 141 is detected, the control unit 11 sets (changes) a function that is allocated to the combination of the touched touch button 141 and the pressed key. In the present embodiment, an operation for instructing setting of a function due to operations of the touch button 141 and the keyboard 13 is referred to as a keyboard selection operation.

For example, a setting pertaining to a basic function such as tuning is allocated to a combination of operations of the function button 141a and keys in the keyboard 13. A setting pertaining to a sound function such as a sound mode is allocated to a combination of operations of the sound mode button 141b and keys in the keyboard 13. A setting pertaining to functions such as a scene or a metronome is allocated to a combination of operations of the scene button 141c and keys in the keyboard 13. A setting pertaining to a function of selecting a piece of music is allocated to a combination of operations of the start/stop button 141d and keys in the keyboard 13. A setting pertaining to a function such as tone is allocated to a combination of operations of the tone button 141e and keys in the keyboard 13.

As illustrated in FIG. 3, a setting for a function allocated to a combination of operations of a touch button 141 and keys in the keyboard 13 includes directly setting a setting value such as a number or an entry, and increasing or decreasing a setting value by 1. FIG. 3 indicates that a setting value is increased by 1 (1 is added thereto) each time a key (pitch name) for which “+” is written in a “setting value” field is pressed once by a user for less than a prescribed amount of time t (a key press for which an amount of time from the key press to the key release is less than the prescribed amount of time t) (t is a positive integer). FIG. 3 indicates that a setting value is decreased by 1 (1 is subtracted therefrom) each time a key for which “−” is stated in a “setting value” field is pressed once by a user for less than the prescribed amount of time t.

Regarding a key for which a setting value is incremented or decremented by 1 due to the performance of one key press of less than the prescribed amount of time t in a state where a prescribed touch button 141 is being pressed, when the key is subjected to a long press that is a continuous key press of the prescribed amount of time t or more in a state where the prescribed touch button 141 is being pressed, the control unit 11 further increments or decrements the setting value by 1, for example, each time the key press continues for the prescribed amount of time t. In this manner, an operation for long-pressing a key for the prescribed amount of time t or more in a state where a prescribed touch button 141 is being pressed in order to cause the setting value to successively change is referred to as a key repeat operation.

In addition, regarding a key for incrementing or decrementing a setting value by 1 due to the performance of one key press for less than the prescribed amount of time t in a state where a prescribed touch button 141 is being pressed, when two keys for increasing/decreasing a setting value are pressed at the same time in a state where the touch button 141 is being pressed by a user, the control unit 11 returns the setting value to an initial setting (a default value). In this manner, an operation for pressing two keys at the same time in a state where a prescribed touch button 141 is being pressed in order to return a setting value to a default value is referred to as a default value setting operation. Note that it is difficult to press two keys at strictly the same time, and a slight deviation arises. Accordingly, the control unit 11 determines that a default value setting operation is detected in a case where, after one of two keys for increasing/decreasing a setting value is pressed, the other key is pressed within a prescribed amount of time t1 (for example, t1=10 msec) while the one of the two key remains pressed (t1<t). In this case, a user believes they have pressed the two keys at the same time, and thus is less likely to ascertain which one they have pressed earlier and which one they have pressed later.

In a case where a function setting is performed in response to a combination of a pressed touch button 141 and a key in the keyboard 13, when a user believes they have performed a correct operation but has performed wrong operation, the user cannot ascertain how a setting value has been changed and how to return to the state for before the operation if there is not a display that can display a setting value (text or number) or a function for which a setting was made, and it becomes difficult to return to the original state. To address this problem, for example, consideration can be given to saving a pre-change setting value in an overwrite fashion each time a setting value is changed, and writing back the setting value to the saved value when execution of an undo function for returning the setting value to the original state is instructed. However, with electronic musical instruments of the past, for example, in a case where an above-described key repeat operation or default operation is performed, returning to the immediately prior setting value does not enable the state before the start of the operation to be returned to.

In an electronic musical instrument of the past, for example, in a case where a current setting value is 5, when the setting value is changed 5→6→7→8→9→10 by a key repeat operation, the value finally saved as the pre-change setting value will be 9. Accordingly, when an operation for making an instruction for an undo function (an undo operation) is performed after the key repeat operation, the setting value returns to 9. In other words, even if an undo operation is performed, it is not possible to return to 5, which is the setting value before the key repeat operation, and it will be difficult for the user to understand how far back an undo operation will return to at the current time.

In addition, in a case where a current setting value is 100, for example, when a default value setting operation is performed to change the setting value to a default value (assumed here to be 64, which is midway between 0 and 127) and then an undo operation is performed, the setting value will return to 99 or 101. To give a detailed description, in the default value setting operation, firstly one of the two keys for increasing/decreasing the setting value is pressed. It is assumed here that the key for “−” is pressed. At this point, the setting value is changed to 99, and 100 is saved as the pre-change setting value. Next, when the other key (the “+” key here) is pressed within the prescribed amount of time t1 while the “−” key is pressed, a default value setting operation is detected and the setting value is changed to 64. The pre-change setting value is saved in an overwrite fashion as 99, which is the immediately prior setting value. When an undo operation is performed after the default value setting operation, the setting value is returned to 99, which was saved as the pre-change setting value. In other words, it is not possible to return to 100 that is the setting value before the default value setting operation, even if an undo operation is performed, and the user will sink into a state of finding it difficult to notice this.

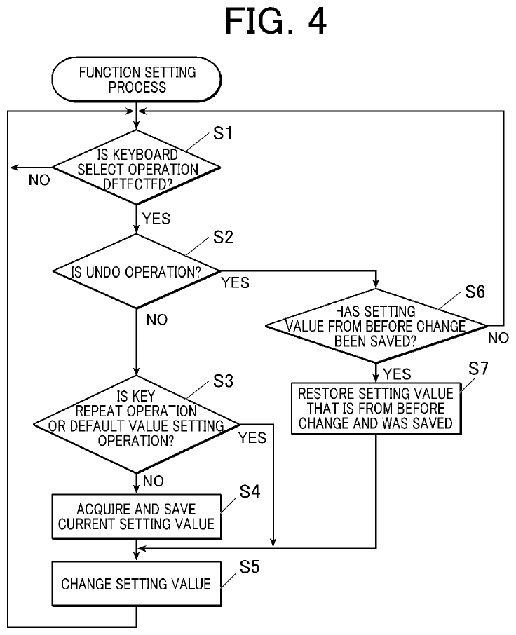

Accordingly, the electronic musical instrument 1 according to the present embodiment executes the function setting process that is illustrated in FIG. 4 to perform control such that, in a case where an undo operation is performed immediately after a specific operation in which a setting value is changed a plurality of times—as with a key repeat operation or a default value setting operation—the setting value is returned to the state before the operation was started. A specific operation in which a setting value is changed a plurality of times includes, for example: a series of operations that include a plurality of operations in which the setting value is changed once for each operation—as with a default value setting operation, for example; and an operation for continuing, over a plurality of unit amounts of time, an operation in which the setting value is changed once every time the operation continues for the unit amount of time—as with a key repeat operation, for example.

The function setting process is executed in accordance with collaboration between the control unit 11 and a program stored in the storage unit 12, while a power supply for the electronic musical instrument 1 is on. Note that an undo operation in the present embodiment is an operation in which a predefined key of the keyboard 13 is pressed while a touch button 141 is pressed, and is thus a keyboard selection operation.

In the function setting process, as illustrated in FIG. 4, firstly the control unit 11 determines whether a keyboard selection operation is detected (step S1). In other words, the control unit 11 determines whether one key of the keyboard 13 has been pressed while one touch button 141 is pressed. In a case of determining that a keyboard selection operation is not detected—in other words, in a case where no touch button 141 is being pressed by a user or no key of the keyboard 13 is pressed despite one of the touch buttons 141 being pressed by a user (step S1: NO), the control unit 11 returns to step S1. In a case of determining that a keyboard selection operation is detected (step S1: YES), the control unit 11 determines whether, as the keyboard selection operation, an undo operation is detected (step S2).

In a case of determining that an undo operation is not detected (step S2: NO), the control unit 11 determines whether, as the keyboard selection operation, a key repeat operation or a default value setting operation is detected (step S3). In a case of determining that neither of a key repeat operation or a default value setting operation is detected (step S3: NO), the control unit 11 acquires, from the current setting value save region 122 in the storage unit 12, a setting value for a function that corresponds to the performed keyboard selection operation, saves the setting value in an overwrite fashion to the pre-change setting value save region 123 (step S4), and transitions to step S5.

A key repeat operation cannot be detected at a timing when an initial key press of the keyboard 13 is detected, is also not able to be detected even in a case where an amount of time that the key press continues from the timing when the initial key press was detected is less than the prescribed amount of time t, but is detected at a point in time when the key press of the keyboard 13 has continued for the prescribed amount of time t. In addition, a default value setting operation also cannot be detected at a timing when an initial key press of the keyboard 13 is detected, but is detected at a point in time when another key is pressed within the prescribed amount of time t1 while the initial key press is maintained. Accordingly, when an initial key press for a key repeat operation or a default value setting operation is detected, the control unit 11 determines NO in step S3 and, in step S4, acquires, from the current setting value save region 122 in the storage unit 12, the current setting value for a function corresponding to a combination of the pressed touch button 141 and the initially pressed key, and saves the acquired setting in an overwrite fashion in the pre-change setting value save region 123 as a setting value for before the start of the operation.

In contrast, in a case of having determined in step S3 that a key repeat operation or a default value setting operation has been detected (step S3: YES), the control unit 11 skips step S4 and transitions to step S5. In other words, after saving to the pre-change setting value save region 123 when the initial key press is detected in the key repeat operation or the default value setting operation, the value in the pre-change setting value save region 123 is not changed. Therefore, a state is entered in which a setting value that was saved by an operation immediately prior to the key repeat operation or a setting value that was saved due to an operation immediately prior to a default value setting operation remains saved in the pre-change setting value save region 123. Note that these immediately prior operations do not include any of a key repeat operation or a default value setting operation.

In step S5, the control unit 11 performs a setting change for the function that corresponds to the performed keyboard selection operation (step S5), and returns to step S1. In other words, the control unit 11 changes the setting value for the function in response to the keyboard selection operation, and the setting value after the change is saved to the current setting value save region 122 in an overwrite fashion. In contrast, in a case of determining in step S2 that an undo operation has been performed (step S2: YES), the control unit 11 determines whether a value has been saved in the pre-change setting value save region 123 (step S6). In a case where it is determined that a value has not been saved in the pre-change setting value save region 123 (step S6: NO), the control unit 11 returns to step S1.

In a cases of determining that a value has been saved in the pre-change setting value save region 123 (step S6: YES), the control unit 11 reads out the setting value that was saved in the pre-change setting value save region 123, saves the read-out setting value to the setting value in the current setting value save region 122 in an overwrite fashion (step S7), and returns to step S1. In other words, the setting value is returned to the setting value that was saved to the pre-change setting value save region 123. In a case where an undo operation is performed after a key repeat operation or a default value setting operation, a setting value before the start of the key repeat operation or default value setting operation will be saved in the pre-change setting value save region 123. Therefore, it will be possible to return the setting value to the setting value before the start of the key repeat operation or default value setting operation. The control unit 11 repeatedly executes processing for steps S1 through S7 while the power supply for the control unit 11 is on.

In this manner, in a case where an undo operation is performed after a key repeat operation or a default value setting operation, the function setting process illustrated in FIG. 4 enables a setting value to be returned to a setting value before the start of the key repeat operation or default value setting operation.

As described above, the control unit 11 in the setting controller 10 in the electronic musical instrument 1 saves, to the pre-change setting value save region 123, a setting value before the start of a specific operation such as a key repeat operation or a default value setting operation in which the setting value is changed a plurality of times and, after the setting value is changed a plurality of times in response to the specific operation and in a case where an undo operation instructing a return to the original state for a changed setting value is performed, the changed setting value is returned to the setting value that is before the start of the specific operation and is saved in the pre-change setting value save region 123. Accordingly, because the setting value can be returned to the setting value that is before the start of the specific operation such as a key repeat operation or a default value setting operation, it is possible to improve convenience. In this manner, even in a situation where it would be difficult for a user to ascertain a number of operations or an operation order because a setting value has changed due to the user themselves performing a specific operation that causes the setting value to change a plurality of times, it is possible to enable the setting value before the start of the specific operation to be easily returned to. In addition, in the present embodiment, when a specific operation such as a key repeat operation or a default value setting operation is detected, there is no need to acquire a setting value for a function corresponding to a performed keyboard selection operation from the current setting value save region 122 in the storage unit 12 and save the setting value in the pre-change setting value save region 123 in an overwrite fashion. Therefore, a load for a write process by the control unit 11 is reduced, and the control unit 11 can also quickly process a setting change for the function corresponding to the performed keyboard selection operation. Note that content described in the above-described embodiment is a desirable example of a setting controller, electronic device, setting change cancellation method, and non-transitory computer-readable medium according to the present disclosure, and there is no limitation thereto. For example, description was given in the above-described embodiment by taking a case in which the present disclosure is applied to the electronic musical instrument 1 as an example, but an electronic device according to the present invention is not limited to the electronic musical instrument 1, and may be another electronic device such as a calculator, for example.

In addition, description was given in the above-described embodiment by taking a case in which a specific operation is a key repeat operation or a default value setting operation as an example, but the specific operation is not limited to a key repeat operation or default value setting operation if the specific operation is an operation for changing a setting value a plurality of times. In addition, in the above-described embodiment, a specific operation such as a key repeat operation or a default value setting operation is given as a combination of operations using two types of controls—a touch button 141 and a key in the keyboard 13, but the specific operation may be an operation with respect to one type of control.

In addition, an example in which a semiconductor memory or a hard disk is used as a computer-readable medium for a program according to the present disclosure was disclosed in the above-described embodiment, but there is not limitation to this example. It is possible to employ a portable recording medium such as an SSD or a CD-ROM as a different computer-readable medium. In addition, a carrier wave is also employed as a medium for providing, via a communication line, data for a program according to the present disclosure.

In addition, changes can be made, as appropriate, even in relation to the detailed configuration and detailed operation of each apparatus included in a setting controller or electronic musical instrument, in a scope that does not deviate from the spirit of the present invention. While embodiments are described above, the technical scope of the present invention is not limited to the embodiments of the present disclosure described above, and is defined on the basis of the scope of the claims. Furthermore, the technical scope of the present invention also includes equivalent scopes resulting from adding changes unrelated to the essence of the present invention to the description in the claims.

What is claimed is:

1. A setting controller, comprising:
at least one processor; and
a memory, wherein
the at least one processor saves, in the memory, a setting value that is before start of a specific operation in which the setting value is changed a plurality of times and, when a single return instruction operation for making an instruction to return the changed setting value to an original state is performed after the setting value is changed the plurality of times in response to the specific operation, the at least one processor returns the changed setting value to the setting value that is before the start of the specific operation and is saved in the memory.

2. The setting controller according to claim 1, wherein
the specific operation includes an operation for continuing, over a plurality of unit amounts of time, an operation in which the setting value is changed once each time the operation continues for a unit amount of time among the unit amounts of time, or a series of operations that includes a plurality of operations in which the setting value is changed once per operation.

3. The setting controller according to claim 1, wherein
the specific operation is performing a prescribed operation with respect to one or more second controls from among a plurality of second controls while one or more first controls are being pressed.

4. The setting controller according to claim 3, wherein
the specific operation is continuing to press a prescribed second control from among the second controls for a prescribed amount of time or more while the one or more first controls are being pressed, and
the at least one processor changes the setting value a number of times that corresponds to an amount of time in which the second control continues to be pressed.

5. The setting controller according to claim 3, wherein
the specific operation is, while the one or more first controls are being pressed, pressing one second control that is one of two prescribed second controls from among the second controls and pressing the other second control that is the other of the two prescribed second controls within a prescribed amount of time from the pressing of the one second control.

6. The setting controller according to claim 5, wherein
the at least one processor increments or decrements the setting value by one in response to the pressing of the one second control, and changes the setting value to an initial value in response to the pressing of the other second control.

7. An electronic device, comprising:
the setting controller according to claim 3; and
the one or more first controls and the one or more second controls.

8. The electronic device according to claim 7, wherein
each of the first controls is an operation button, and
each of the second controls is a key in a keyboard for designating a pitch of a sound to output.

9. A setting change cancellation method, wherein
a computer
saves, in a memory, a setting value that is before start of a specific operation in which the setting value is changed a plurality of times and, when a single return instruction operation for making an instruction to return the changed setting value to an original state is performed after the setting value is changed the plurality of times in response to the specific operation, returns the changed setting value to the setting value that is before the start of the specific operation and is saved in the memory.

10. The setting change cancellation method according to claim 9, wherein
the specific operation includes an operation for continuing, over a plurality of unit amounts of time, an operation in which the setting value is changed once each time the operation continues for a unit amount of time among the unit amounts of time, or a series of operations that includes a plurality of operations in which the setting value is changed once per operation.

11. The setting change cancellation method according to claim 9, wherein
the specific operation is performing a prescribed operation with respect to one or more second controls from among a plurality of second controls while one or more first controls are being pressed.

12. The setting change cancellation method according to claim 11, wherein
the specific operation is continuing to press a prescribed second control from among the second controls for a prescribed amount of time or more while the one or more first controls are being pressed, and
the computer changes the setting value a number of times that corresponds to an amount of time in which the second control continues to be pressed.

13. The setting change cancellation method according to claim 11, wherein
the specific operation is, while the one or more first controls are being pressed, pressing one second control that is one of two prescribed second controls from among the second controls and pressing the other second control that is the other of the two prescribed second controls within a prescribed amount of time from the pressing of the one second control.

14. The setting change cancellation method according to claim 13, wherein
the computer increments or decrements the setting value by one in response to the pressing of the one second control, and changes the setting value to an initial value in response to the pressing of the other second control.

15. A non-transitory computer-readable medium storing a program for causing a computer to:
execute a process for saving, in a memory, a setting value that is before start of a specific operation in which the setting value is changed a plurality of times and, when a single return instruction operation for making an instruction to return the changed setting value to an original state is performed after the setting value is changed the plurality of times in response to the specific operation, returning the changed setting value to the setting value that is before the start of the specific operation and is saved in the memory.
